(19) United States
(12) Patent Application Publication
(10) Pub. No.: US 2011/0221084 A1
(43) Pub. Date: Sep. 15, 2011

(54) Honeycomb composite silicon carbide mirrors and structures

(75) Inventors: William Goodman, Albuquerque, NM (US); Clifford T. Tanaka, Lihue, HI (US)

(73) Assignee: Trex Enerprises Corp.

(21) Appl. No.: 13/065,042

(22) Filed: Mar. 10, 2011

Related U.S. Application Data
(60) Provisional application No. 61/339,851, filed on Mar. 10, 2010.

(51) Int. Cl. C01B 31/00

(52) U.S. Cl. 264/29.5

(57) ABSTRACT

Honeycomb silicon carbide composite mirrors and a method of making the mirrors. In a preferred embodiment the mirror is made from a carbon fiber preform molded into a honeycomb shape using a rigid mold. The carbon fiber honeycomb is densified using polymer infiltration pyrolysis or reaction with liquid silicon. A chemical vapor deposited or chemical vapor composite process is utilized to deposit a polishable silicon or silicon carbide cladding on the honey comb structure. Alternatively, the cladding may be replaced by a free standing replicated CVC SiC facesheet that is bonded to the honeycomb.

### CROSS REFERENCE TO RELATED APPLICATIONS

This application claims the benefit of Provisional Patent Application Ser. No. 61/339,851 filed Mar. 10, 2010.

### FIELD OF THE INVENTION

The present invention relates to lightweight silicon carbide (SiC) composites and in particular to light weight SiC-composite mirrors.

### BACKGROUND OF THE INVENTION

### Silicon Carbide

Silicon carbide was discovered by Edward Goodrich Acheson around 1893. He not only developed the electric batch furnace by which SiC is still made today, but also formed The Carborundum Company to manufacture it in bulk, initially for use as an abrasive. Purer silicon carbide can be made by the more expensive process of chemical vapor deposition (CVD). Applicant's employer is the assignee of two patents (U.S. Pat. Nos. 5,154,862 and 5,348,765, both of which are incorporated by reference herein) covering a CVD-type process for making silicon carbide in which tiny particles are entrained in the chemical vapor. Silicon carbide made with this process possess improved properties such as increased toughness and reduced stress. Commercial large single crystal silicon carbide is grown using a physical vapor transport commonly known as modified Lely method. Purer silicon carbide may also be made by the thermal decomposition of a polymer, poly(methylsilane), under an inert atmosphere at low temperatures. This has certain advantages over the CVD process in that the polymer may readily formed into various shapes prior to thermolization into a silicon carbide ceramic. Naturally occurring silicon carbide is called “moissanite” and is extremely rare, as it is not formed naturally in any quantity within the Earth, and thus is found only in tiny quantities in certain types of meteorite and as microscopic traces in corundum deposits and kimberlite.

Alpha silicon carbide (a-Sic) is most common, and is formed at temperatures greater than 2000° C. Alpha Sic has the typical hexagonal crystal structure. Beta modification, with a face-centered cubic crystal structure, is formed at temperatures of below 2000° C. Silicon carbide has a specific gravity of 3.2, and its high melting point (approximately 2700° C.) makes silicon carbide useful for bearings and furnace parts. It is also highly inert chemically. SiC also has very low thermal expansion coefficient and no phase transitions that would cause discontinuities in thermal expansion. Pure Sic is clear. As a gemstone, silicon carbide is similar to diamond in several important ways: it is transparent and extremely hard (9.25 on the Mohs scale, compared to 10 for diamond), with an index of refraction between 2.65 and 2.69 (compared to 2.42 for diamond). Sic has a hexagonal crystal structure. In the 1980s and 1990s, silicon carbide was studied on several research programs for high-temperature gas turbines in the United States, Japan, and Europe. The components were intended to replace nickel superalloy turbine blades or nozzle vanes. However, none of these projects resulted in a production quantity, mainly because of its low impact resistance and its low fracture toughness. Silicon carbide's hardness and rigidity make it a desirable mirror material for astronomical work, although they also make manufacturing and finishing such mirrors quite difficult.

### Lightweight Mirror Materials

Lightweight mirrors are utilized in space and airborne applications for detection, surveillance, imaging and tracking. These mirrors typically consist of an optical quality facesheet reinforced with a rear ribbing structure to maintain rigidity of the mirror. The ribbing structure is typically produced by grind, milling or in some way machining material from one side of a thick slab. Consequently, costs for these mirrors are very high, since extensive machining is required and the bulk of the material is essentially a waste product.

Candidate materials for lightweight mirrors must ideally have high rigidity to weight ratio. The metric for this is typically defined as specific stiffness, defined as the Young's modulus divided by the material density. The mirror materials with the highest specific stiffness are beryllium (155 MPa-m³/kg) and SiC (143 Mpa-m³/kg). Beryllium has been utilized extensively, although its high toxicity and high cost means that SiC is a highly desirable alternative. SiC also has the advantage over beryllium of low thermal expansion and high thermal conductivity, which means higher thermal stability. Other mirror materials include aluminum and glass, but those materials are several times less stiff than either beryllium or SiC.

### Method of Manufacturing Composite Honeycomb Material

The method of manufacturing composite honeycomb from carbon fiber prepreg was developed, perfected and patented by Ultracor of Livermore, California. The process maximizes the mechanical and thermal parameters of the material by laying up and curing the material in the manner recommended by the prepreg manufacturer. The prepreg material is highly compliant with no inherent ability to maintain its shape in the uncured state. It is readily formed into a honeycomb or other complex shapes by utilizing forming mandrels, much like the waffle maker machine. When Applicants refer to “honeycombs”, they are referring to honeycombs comprised of uniform or approximately uniform cells having all vertices the same. There are 28 convex examples (Grunbaum & Shepherd, Uniform tilings of 3-space) also called the Archimedean honeycombs. These include cubes, hexagonal prisms and regular triangular prisms. These also include honeycombs of the type shown in FIG. 2.

### Development of Carbon-Carbon Honeycomb

Carbon-carbon honeycomb (CCH) was developed a decade ago to meet the requirements of thermal management in space applications. The process for manufacturing CCH is a straightforward conversion of existing carbon fiber honeycomb. Ultracor outsources the charring of the volatiles from the structure and the carbon infiltration of the honeycomb. The process used is a chemical vapor infiltration (CVI) process, including a final temperature treatment up to 5,000° F. to maximize the thermal conductivity of the material. The resultant material has a high thermal conductivity (about 360 W/m-K in plane, 65 W/m-K in the Z direction). An example CCH panel is shown in FIG. 3. CCH is currently flying in a thermal management system of the GOCE satellite. It is also under development as a standard instrument bench by a major commercial satellite manufacturer.

### SUMMARY OF THE INVENTION

The present invention provides lightweight, stiff silicon carbide composite mirrors and a method of making said mirrors.

In a preferred embodiment, the mirror consists of:
(1) a carbon fiber reinforced ceramic matrix composite honeycomb core panel structure made from a molded preform that has been converted to or infiltrated with silicon carbide;
(2) a polishable CVC SiC, silicon, or glass cladding layer that is deposited on the facesheet panel of the carbon fiber reinforced ceramic matrix composite honeycomb core panel structure.

In another preferred embodiment, both the honeycomb structure and facesheet are made of silicon carbide fibers converted or infiltrated with silicon carbide, with a polishable cladding of SiC or silicon applied to the front face of the mirror using chemical vapor deposition.

The honeycomb structure is made by pressing a layered, woven fiber (carbon based or silicon carbide) form into a rigid mold, which is the mirror image of the desired component. An epoxy or phenolic resin, or polycarbosilane is then flowed into the fiber form and upon curing forms a solid, rigid structure. Charring at high temperature removes the volatiles from the resin and creates a porous, rigid fiber reinforced structure with a carbonaceous or pre-silicon carbide matrix material. The rigid, fiber reinforced structure is converted to SiC ceramic composite material by one of three methods:
(1) polymer infiltration pyrolysis,
(2) liquid infiltration with silicon or
(3) chemical vapor infiltration.

A cladding of Si or SiC can then be deposited on the mirror facesheet using chemical vapor deposition.

The polished CVC SiC facesheet can be produced by replication on an polished silicon carbide master mandrel clad with an appropriate release layer. Coating a polished silicon carbide master mandrel with a release layer and vapor depositing CVC SiC onto it should result in a reflective, figured deposit that is easy to remove from the mandrel. The resulting facesheet can be attached to the honeycomb core panel structure using diffusion or other bonding method.

The resulting fiber reinforced silicon carbide honeycomb structure will be a ceramic matrix composite material with high stiffness and mechanical strength, high thermal conductivity, low CTE, and rapid, inexpensive manufacturing. The material will be electrically conductive allowing precision wire and sinker electronic discharge machining (EDM) to directly thread the material. Electrical conductivity will also be useful for dissipating charge buildup in the space environment.

### BRIEF DESCRIPTION OF THE DRAWINGS

FIGS. 1 and 2 are images of honeycomb structures.

### DETAILED DESCRIPTION OF PREFERRED EMBODIMENTS

The primary purpose of this invention is to manufacture ultra-low-cost precision optical systems for very large x-ray, UV/optical or infrared telescopes. Potential solutions include but are not limited to direct precision machining, rapid optical fabrication, slumping or replication technologies to manufacture 1 to 2 meter (or larger) precision quality mirror or lens segments (either normal incidence for UV/optical/infrared or grazing incidence for x-ray).

One of the major problems perceived for conventional silicon carbide mirrors is the cost associated with machining, light-weighting and polishing the mirrors. Indeed these processes are labor, schedule, risk and cost drivers. Applicants have created and demonstrated a new silicon carbide material that overcomes these cost drivers. The new material achieves light-weighting of 92% relative to bulk material and net production cost on the order of $38,000 per square meter (unpolished) which is much less than the $1 million to $2 million per square meter of current state-of-the-art beryllium and glass mirror blanks. The prepreg raw material is about 25% of the overall cost.

Applicants have demonstrated a manufacturing process for the new ceramic matrix composite honeycomb panel silicon carbide (HoneySiC or H—SiC) which nearly eliminates the machining and light-weighting process steps for mirrors and opto-mechanical structures. Web thickness, core geometries (pocket depth, pocket size), and mirror shape are easily tailored since the preferred mirror material, H—SiC, starts as a molded fiber prepreg material.

### Composite Honeycomb Material and Panels

For prototype mirror units Applicants used Ultracor carbon fiber composite honeycomb material as a precursor for making silicon carbide honeycomb material. The method of manufacturing composite honeycomb from carbon fiber prepreg was developed, perfected and patented by Ultracor of Livermore, California. The process maximizes the mechanical and thermal parameters of the material by laying up and curing the material in the manner recommended by the prepreg manufacturer. The prepreg material is highly compliant with no inherent ability to maintain its shape in the uncured state. It is readily formed into a honeycomb or other complex shapes by utilizing forming mandrels, much like the waffle maker machine seen at many hotel breakfast buffets.

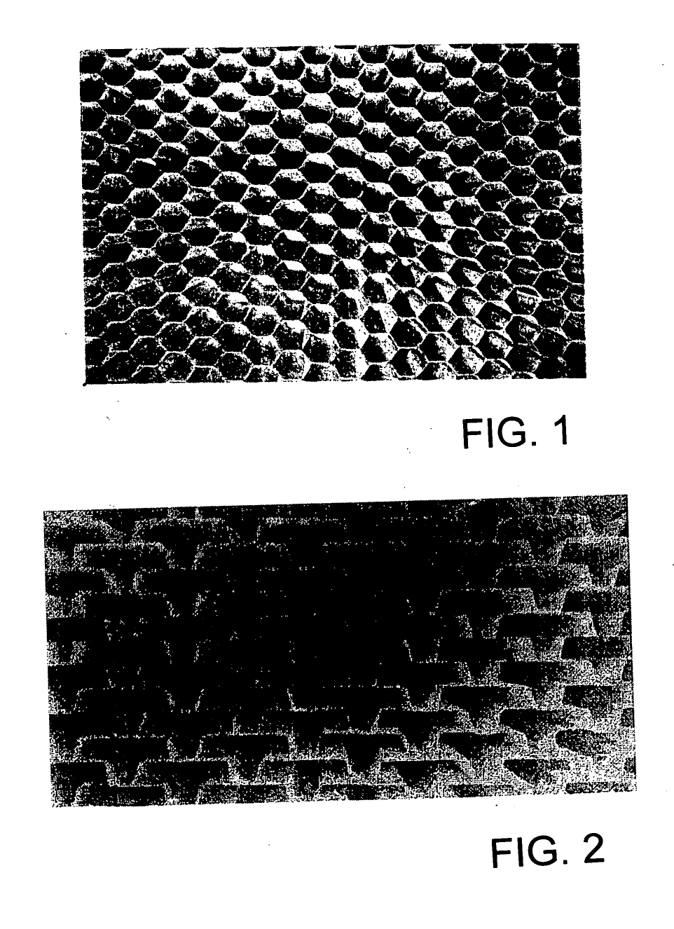

As can be seen in FIG. 1, each cell is completely uniform, maintaining the shape of the inserted mandrel. Furthermore, the layup creates pressure that insures node bond strength. Each node is a composite laminate utilizing only the inherent resin system to form the bond. This contrasts starkly with the other known method of producing composite honeycomb, in which individual corrugations are formed, cured and then bonded together in a secondary process. The same molding process can be employed to make panels or mirror face-sheets that can be bonded to the honeycomb cores, forming a monolithic, internally light-weighted structure or mirror substrate. Therefore, Ultracor honeycomb is an expanded composite laminate with superior mechanical performance.

### Sizes, Shapes and Densities of Composite Honeycomb

By varying the size of the mandrels within the layup, varying degrees of density can be achieved. Typical sizes are ⅜″ and 3/16″. Cell sizes up to 1″ have been manufactured. Similarly, the shape of the core can be altered. A flexible honeycomb structure is shown in FIG. 2.

The latter honeycomb material, when used as a core, can be closed-out on one or both sides with a face-sheet made of the same material to form a panel or a lightweight mirror substrate. Applicants have produced prototype single skin and dual skin panels in sizes of 12.0 by 12.0 by 0.5 inch. Applicants have produced prototype dual-skin mirror substrates in both off-axis and on-axis concave parabolic configurations.

The baseline configuration for the face-sheets and honeycomb core is described below. The face-sheets are composed of a stack of angle-ply material at angles of plus and minus theta, where theta is an acute angle with the principal laminate axis. The layers of angle plies form a cloth which is interlaced with fibers in specific orientations to provide quasi-isotropic material properties in the plane of the facesheet. The orientations of the demonstration face-sheets were:
Layer 1: 0/90 degrees;
Layer 2: ±45 degrees;
Layer 3: 90/0 degrees;
Layer 4: ±45 degrees;
2 fiber layers pointed to the degree points 0, 45, 90, 135, and 180.

The honeycomb cores were simply constructed of a ±45 degrees cross-ply cloth. It is noteworthy, that for minor additional cost, that completely isotropic face-sheets can be made by incorporating fibers with the ±22.5 degree points, and that the honeycomb cores could be made with a true 60/60/60 triax fabric. A theoretically infinite number of lay-ups are possible, allowing tailoring of the resultant properties of the ceramic composite material.

### Development of Carbon-Carbon Honeycomb

Applicants utilize the Carbon-carbon honeycomb (CCH) developed by Ultracor which is described in the background section. An example CCH panel is shown in FIG. 6. CCH is currently flying in a thermal management system of the GOCE satellite. It is also under development as a standard instrument bench by a major commercial satellite manufacturer.

Applicants successfully produced CCH coupons using the same techniques. The charring process maintains the coupons at the peak temperature of 815° C. for at least 11 hours. The density of the CCH is about 1.0 g/cm³. After inspecting the coupons they were impregnated with polycarbosilane and underwent multiple cycles of polymer infiltration pyrolysis (PIP) to convert them to carbon fiber reinforced silicon carbide ceramic composite matrix material that Applicants refer to as “HoneySiC”.

### How to Make a HoneySiC Mirror

In a first preferred embodiment, the mirror blank is constructed as follows:
1) Carbon fiber, which may be pitch or polyacrylonitrile (PAN) based fiber, or silicon carbide fiber, is woven into cloth.
2) The cloth is layed up and molded into a preform using a rigid mold that is the mirror image of the desired component.
3) There are three components to the mirror and each requires a separate and specific mold: a) a front face-sheet which will become the surface of the mirror, b) a back face-sheet, and c) a honeycomb core which is sandwiched between the two faceplates. Molds may be made from plastic, aluminum, steel or other common and inexpensive materials. A mold is essentially a cavity formed by two separate parts that are sandwiched together. The cavity of the back faceplate mold is typically a simple shape such as plano (flat), convex, or concave. The cavity of the front faceplate mold can be quite complex since this will create the optical prescription of the mirror. Typical simple mirror optical prescriptions have shapes that are plano (flat), convex, or concave. Additionally, various and more complicated optical geometries can be incorporated to shape the faceplate to the desired mirror geometry. Examples include on-axis and off-axis paraboloas, ellipsoids, and hyperbolas.
4) Epoxy, phenolic resin, or polycarbosilane is flowed into the molds, which upon curing creates rigid structures.
5) The front and back faceplates are then bonded to the honeycomb core using epoxy, phenolic resin or polycarbosilane creating the mirror substrate in the form a fiber reinforced composite.
6) The part is charred at elevated temperatures between 600-1000° C. in inert atmosphere, creating a porous C—C or C—SiC composite material.
7) A preceramic polymer precursor for silicon carbide (SiC) is flowed into the preform, e.g., polycarbosilane.
8) The preform is fired at high temperatures of 600-1200° C., which converts the polymer into SiC.
9) Steps (5) and (6) are repeated until the desired density of material is achieved.
10) A polishable CVD or CVC SiC cladding is deposited on the front face of the mirror blank.

The resulting carbon fiber reinforced silicon carbide honeycomb structure is a ceramic matrix composite material with high stiffiiess and mechanical strength, high thermal conductivity, low CTE, and rapid, inexpensive manufacturing. The resultant carbon fiber reinforced silicon carbide (HoneySiC) material is electrically conductive allowing precision wire and sinker electronic discharge machining (EDM) to directly thread the material. Electrical conductivity will be useful for dissipating charge buildup in the space environment.

### Comparison with Prior Art SiC Mirror Blank Material

HB-Cesic® made by ECM in Germany represents the state-of-the-art in ceramic matrix composite silicon carbide for optical applications. The starting material for HB-Cesic® is short, chopped, randomly oriented carbon fiber cloth material, consisting of both pitch-based and other fibers. The fibers are mixed with a phenolic resin and molded into a blank, which then is heat-treated under vacuum. The result is a lightweight, porous, relatively brittle carbon-carbon (C/C) greenbody. Circular blanks are available in sizes up to 1.6-m diameter, with a thickness up to 200-mm. In the near future greenbody blocks of 2-m or larger will become available. ECM has a large CNC controlled milling machine (2.5-m×1.75-m) in-house. It is used to manufacture large, light-weighted mirrors and optical bench components. Curved face sheets (including off-axis designs) can be machined with reinforcing ribs as thin as 1-mm and of any geometry, including ribs with vent holes or I- or T-beam configurations for increased stiffness. The machined greenbody is subsequently infiltrated under vacuum conditions with liquid silicon at temperatures >1600° C. Capillary forces wick the silicon throughout the porous greenbody, where it reacts with the carbon matrix and the surfaces of the carbon fibers to form carbon-fiber reinforced. The density of HB-Cesic® composite is around 2.98 g/cm³. In comparison, the density of classic Cesic® material is 2.65 g/cm³. After controlled cool-down, the HB-Cesic® structure is carefully examined visually and by other NDT methods, such as dye penetrant or ultrasonic tests. The structure is then micro-machined with suitable diamond tools or by EDM machining to achieve the required surface figure and interface geometry (e.g., mirror adaptation and mounting). EDM machining is possible because HB-Cesic has good electrical conductivity. This machining method is fast compared to grinding, it is relatively inexpensive, and it yields a surface and location accuracy (e.g., for screw holes and mounts) of about 10 μm tolerance over a large area. Manufacturing times of HB-Cesic® mirrors and other structures are typically only a few weeks. Highly complex and large projects take somewhat longer, e.g., mirrors with closed-backs, meter-plus-class mirrors that require precision joining of greenbody or infiltrated segments, and large multi-segmented optical benches. The maximum size of HB-Cesic components is only limited by the size of the Si-infiltration furnaces. ECM's current largest furnace, FIG. 13, has a useable diameter of 2.4-m with up to three levels, each of height 1.2 meters. Applicants' process described above substantially eliminates the costly machining step inherent in the German technology.

### Other Preferred Embodiments

In a second preferred embodiment, the mirror is constructed as follows, the primary difference from the above embodiments being that the faceplates of the mirror are generated via replication of the optical surface, resulting in an overall manuafacturing cost efficiency for the minor:
(1) Carbon fiber, which may be pitch or polyacrylonitrile (PAN) based fiber, or silicon carbide fiber, is woven into cloth.
(2) The cloth is layed up and molded into a preform using a rigid mold that is the mirror image of the desired component.
(3) Epoxy or phenolic resin is flowed into the mold, which upon curing creates a rigid structure.
(4) The part is charred at elevated temperatures between 600-1000° C. in inert atmosphere, creating a porous C—C composite material.
(5) A preceramic polymer precursor for SiC is flowed into the preform, e.g., polycarbosilane.
(6) The preform is fired at high temperatures of 600-1200° C., which converts the polymer into SiC.
(7) Steps (5) and (6) are repeated until the desired density of material is achieved.
(8) As a separate component, a polished CVC SiC facesheet is created by replication of the optical surface using a polished master mandrel. The master may be a polished CVC SiC or pyrolytic carbon piece with release coating of iridium or other noble metal. The facesheet is deposited by CVC SiC process onto the mandrel and separated to achieve a good optical finish.
(9) The CVC SiC mirror facesheet and honeycomb SiC composite are bonded utilizing reaction bonding, diffusion bonding or polymer-infiltration-pyrolysis.

In another preferred embodiment, the mirror blank is constructed as follows, the primary difference from the above embodiments being that the C—C honeycomb core and C—C faceplates are converted to reaction bonded silicon carbide via reaction with molten silicon, resulting in a lower content of carbon in the composite and consequently a better match of coefficient of thermal expansion to the cladding layer:
(1) Carbon fiber, which may be pitch or polyacrylonitrile (PAN) based fiber, or silicon carbide fiber, is woven into cloth.
(2) The cloth is laid up and molded into a preform using a rigid mold that is the mirror image of the desired component.
(3) There are three components to the mirror and each requires a separate and specific mold: a) a front face-sheet which will become the surface of the mirror, b) a back face-sheet, and c) a honeycomb core which is sandwiched between the two faceplates. Molds may be made from plastic, aluminum, steel or other common and inexpensive materials. A mold is essentially a cavity formed by two separate parts that are sandwiched together. The cavity of the back faceplate mold is typically a simple shape such as plano (flat), convex, or concave. The cavity of the front faceplate mold can be quite complex since this will create the optical prescription of the mirror. Typical simple mirror optical prescriptions have shapes that are plano (flat), convex, or concave. Additionally, various and more complicated optical geometries can be incorporated to shape the faceplate to the desired mirror geometry. Examples include on-axis and off-axis paraboloas, ellipsoids, and hyperbolas.
(4) Epoxy, phenolic resin, or polycarbosilane is flowed into the molds, which upon curing creates rigid structures.
(5) The front and back faceplates are then bonded to the honeycomb core using epoxy, phenolic resin or polycarbosilane creating the mirror substrate in the form a fiber reinforced composite.
(6) The part is charred at elevated temperatures between 600-1000° C. in inert atmosphere, creating a porous C—C composite material.
(7) The C—C composite preform is reacted with molten silicon to form a dense silicon-silicon carbide composite.
(8) A polishable CVD or CVC SiC cladding is deposited on the front face of the mirror blank.

### Variations

The above described embodiments of the present invention have been described in detail. Persons skilled in the art will recognize that many variations of the present invention are possible. For example, the carbon based fibers are replaced with silicon carbide fibers to provide a higher overall percentage of silicon carbide in the ceramic matrix composite, and in turn a higher stiffness structure. As another example, epoxy or phenolic resin is replaced by polycarbosilane polymer to provide a higher overall percentage of silicon carbide in the ceramic matrix composite, and in turn a higher stiffness structure. Another variation is the use of silicon monoxide or silicon dioxide gas in the infiltration step. The silicon in the gas will react with carbon in the CCH to produce silicon carbide. The present invention includes SiC honeycomb structures other than mirrors. These structure may include two face plates, only one face plate or no face plate at all.

Therefore, the scope of the present invention should not be limited to the above described preferred embodiments, but by the appended claims and their legal equivalence.

What is claimed is:

1. A method of making a composite silicon carbide honeycomb structure, said method comprising the steps of:
A) producing a carbon fiber woven cloth,
B) laying up the carbon fiber cloth and molding into a honeycomb preform using a rigid mold,
C) flowing epoxy or phenolic resin into perform,
D) firing preform at high temperature to create a porous carbon-carbon body,
E) a preceramic precursor for silicon carbide is flowed into the porous,
F) the polymer infiltrated preform is fired (pyrolyzed) at high temperature to convert the polymer to silicon carbide, and
G) repeating steps E) and F) until dense part is achieved.

2. The method as in claim 1 and further comprising a steps producing at least one composite SiC facesheet and fixing it to the composite SiC honeycomb structure.

3. The method as in claim 2 and further comprising a step of utilizing a chemical vapor deposition or chemical vapor composite process to add a polishable silicon or silicon carbide cladding to the at least one composite facesheet.

4. The method as in claim 2 wherein the at least one face plate includes a polished CVC SiC mirror facesheet that is replicated utilizing a polished CVC SiC master mandrel with iridium release coating, and said facesheet is joined to the honeycomb composite SiC by reaction bonding.

5. The method as in claim 4 wherein the release coating utilized is Pt or other noble metal.

6. The method as in claim 2 wherein the facesheet is joined to the honeycomb composite SiC by diffusion bonding.

7. The method as in claim 2 wherein the facesheet is joined to the honeycomb composite SiC by polymer infiltration pyrolysis.

8. The method as in claim 4 wherein the master mandrel is a polished pyrolytic carbon substrate.

9. The method as in claim 2 wherein the master mandrel is a polished pyrolytic carbon coated graphite substrate.

10. The method as in claim 4 wherein the master mandrel is a polished pyrolytic carbon coated silicon carbide substrate.

11. The method as in claim 1 wherein the preceramic precursor is a polymer.

12. The method as in claim 1 wherein the preceramic precursor is molten silicon.

13. The method as in claim 1 wherein the preceramic precursor is gaseous silicon monoxide.

14. The method as in claim 1 wherein the preceramic precursor is gaseous silicon dioxide.

15. The method as in claim 1 wherein the preceramic precursor is polycarbosilane.

16. The method as in claim 1 wherein the fiber woven cloth is made with silicon carbide fibers.
